(19) United States
(12) Patent Application Publication
(10) Pub. No.: US 2025/0348981 A1
(43) Pub. Date: Nov. 13, 2025

(54) GENERATIVE MACHINE LEARNING MODELS FOR INPAINTING IMAGES AND AUXILIARY IMAGES

(71) Applicant: Apple Inc., Cupertino, CA (US)

(72) Inventors: Alok Deshpande, Los Altos, CA (US); Paul M. Hubel, Mountain View, CA (US); Etienne Guerard, Cupertino, CA (US); Piotr J. Stanczyk, San Francisco, CA (US)

(21) Appl. No.: 19/053,367

(22) Filed: Feb. 13, 2025

Related U.S. Application Data
(60) Provisional application No. 63/646,339, filed on May 13, 2024.

(51) Int. Cl. G06T 5/77; G06T 3/40; G06T 5/50; G06T 5/60; G06T 7/11; G06T 7/50

(52) U.S. Cl. CPC G06T 5/77; G06T 3/40; G06T 5/50; G06T 5/60; G06T 7/11; G06T 7/50; G06T 2207/20021; G06T 2207/20081; G06T 2207/20224

(57) ABSTRACT

Disclosed are systems, apparatuses, processes, and computer-readable media for processing one or more images. For example, a method includes obtaining an inpainted image based on providing a first image to an ML model; combining the first image and a first auxiliary image of the first image into an intermediate image; obtaining an inpainted intermediate image based on providing the intermediate image to the ML model; and generating a second auxiliary image from the inpainted image and the inpainted intermediate image.

### CROSS-REFERENCE TO RELATED APPLICATIONS

This application claims the benefit of priority to U.S. Application No. 63/646,339, filed May 13, 2024, titled “GENERATIVE MACHINE LEARNING MODELS FOR INPAINTING IMAGES AND AUXILIARY IMAGES”, which is hereby expressly incorporated herein by reference in its entirety.

### FIELD

The present disclosure generally relates to capture and processing of images or frames. For example, aspects of the present disclosure relate to generative machine learning models for inpainting images and auxiliary images.

### BACKGROUND

A camera serves as a sophisticated tool capable of capturing light and transforming it into images or frames through the utilization of an image sensor. These images or frames can encompass various forms, including still images or sequences of video frames. Cameras also include complex settings that are, categorized into image-capture and image-processing parameters and allow users to tailor the appearance of their photographs or videos according to their preferences.

Image-capture settings play a pivotal role in influencing the characteristics of an image during the capture process. Prior to or during image capture, adjustments can be made to parameters such as ISO, exposure time (commonly known as shutter speed), aperture size (referred to as f/stop), focus, and gain. Each of these settings contributes uniquely to the final outcome, enabling users to control factors like brightness, depth of field, and motion blur. Additionally, cameras offer a host of image-processing settings designed for post-capture manipulation. These settings encompass alterations to contrast, brightness, saturation, sharpness, levels, curves, and colors, among others. By harnessing the power of both image-capture and image-processing settings, photographers and videographers can exercise creative control over their visual content, achieving their desired aesthetic with precision and finesse.

### SUMMARY

The devices, circuits, components, or apparatuses (hereinafter, devices) described herein may be components of a device or may be integrated into a larger unit. As an example, the devices, circuits, engines, or apparatuses may be implemented in a mobile device (e.g., a mobile telephone or other mobile device), a wearable device, a wireless communication device, an augmented reality (AR), extended reality (XR), or virtual reality (VR) device such as a VR headset, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof.

The devices may include a camera or multiple cameras for capturing one or more images, and in some cases, can include a display or multiple displays for displaying one or more images, notifications, and/or other displayable data. Each device can include one or more sensors (e.g., one or more inertial measurement units (IMUs), such as one or more gyroscopes, one or more gyrometers, one or more accelerometers, or any combination thereof, and/or other sensor.

### BRIEF DESCRIPTION OF THE DRAWINGS

Illustrative embodiments of the present application are described in detail below with reference to the following drawing figures:

FIG. 1 is a diagram illustrating an example of an electronic device including a system-on-chip (SoC) for performing various operations in accordance with some examples;

FIG. 2 is a diagram illustrating a conceptual block diagram of an image synthesis system for synthesizing a group image based on a key image and objects in other images in accordance with some examples;

FIG. 3 is a flow diagram illustrating an example of a process for synthesizing a group image based on a key image and objects in other images in accordance with some examples;

FIG. 4 is a block diagram of an inpainting system for inpainting based on subtractive synthesis in accordance with some examples;

FIGS. 5A to 5C illustrate examples of content used in connection with the inpainting system in accordance with some examples;

FIG. 6A is a block diagram of an inpainting system for inpainting based on transformation mapping in accordance with some examples;

FIG. 6B is a block diagram of an inpainting system for inpainting based on transformation mapping in accordance with some examples;

FIG. 7 is a flow diagram illustrating an example of a process for inpainting images and auxiliary images in accordance with some examples;

FIG. 8 is a flow diagram illustrating an example of a process for inpainting images and auxiliary images in accordance with some examples; and

FIG. 9 is a diagram illustrating an example of a computing system for implementing certain aspects described herein.

The figures depict, and the detailed description describes, various non-limiting aspects for purposes of illustration only.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Electronic devices such as extended reality (XR) devices, virtual reality (VR) devices, augmented reality (AR) devices, mixed reality (MR) devices, etc., mobile phones, wearable devices such as watches, tablets, laptops, etc.) are increasingly equipped with cameras to capture image or frames. For example, an electronic device can include a camera to allow the electronic device to capture a video or image of a scene, a person, an object, etc. Additionally, cameras themselves are used in a number of configurations (e.g., handheld digital cameras, digital single-lens-reflex (DSLR) cameras, worn cameras (including body-mounted cameras and head-borne cameras), stationary cameras (e.g., for security and/or monitoring), vehicle-mounted cameras, etc.).

Generative machine learning (ML) models can be deployed to remove undesirable content from images by inpainting undesirable pixels from an image. Inpainting is a digital image processing technique used to fill in areas of an image by intelligently synthesizing information from surrounding regions. Inpainting processes include analyzing the surrounding pixels to understand the texture, color, and structure of the image, and then using this information to generate new pixels to replace the damaged or undesirable pixels. For example, generative ML models can remove a particular background object or foreground object. However, images also include metadata and other auxiliary images to enhance the visual fidelity. For example, extended dynamic range display technologies such as organic light emitting diode (OLED) and micro-LED use metadata and auxiliary images to increase luminance, color accuracy, and contrast ratio. In addition, advanced display technologies can individually control the brightness of each pixel with precision to increase the dynamic range, luminance, and visual fidelity. As an example, images may include an auxiliary image such as a gain map to identify brightness and contrast regions within the image. A display may use the auxiliary image to apply additional luminance to highlight regions and increase the dynamic range of a displayed image.

Applying a generative ML model to inpaint an image will also require inpainting of an auxiliary image. However, the inpainting of the auxiliary image will require a second inference, which increases the total inference time and power consumption. In addition, applying a generative ML model to an auxiliary image will produce undesirable effects because the stochastic nature of the modifications applied to the auxiliary image will be different from the modifications to the original pixels of the image. For example, the image can be modified in such a manner that a halo effect surrounds the replaced content. The texture of objects can also appear different. The different inferences reduce the visual fidelity.

The present technology pertains to inpainting images and auxiliary images. For example, the systems and techniques include obtaining an inpainted image based on providing a first image to an ML model, combining the first image and a first auxiliary image of the first image into an intermediate image, obtaining an inpainted intermediate image based on providing the intermediate image to the ML model; and generating a second auxiliary image from the inpainted image and the inpainted intermediate image. In this case, the ML model is configured to inpaint an unblended image (with respect to an auxiliary image) and a blended image (with respect to an auxiliary image). For example, a gain map can be blended into the image. The ML is configured to inpaint blended and unblended images in a similar manner, which can then be used to generate a gain map based on substrative synthesis.

In some aspects, the systems and techniques include using local-based transformations of different images to generate an auxiliary image (e.g., a gain map, a depth map, etc.). In this aspect, the systems and techniques require a single inpainted image, and the ML model is trained to inpaint only unblended images.

Various aspects of the application will be described with respect to the figures.

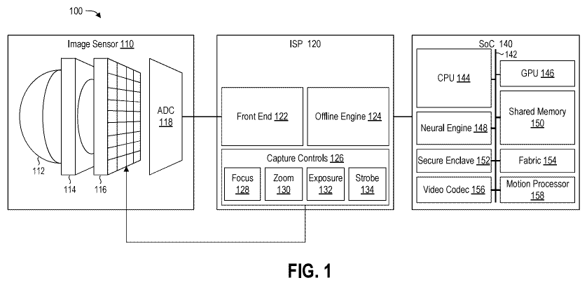

FIG. 1 is a block diagram illustrating an architecture of an electronic device 100 including an image sensor 110 for capturing various types of images. For example, the 100 can capture standalone images (or photographs) and/or can capture videos that include multiple images in a particular sequence (a live photo, a time-lapse, video frames, etc.).

The image sensor 110 includes a lens 112 or a lens assembly is positioned in front of a control mechanism 114. Light enters the image sensor 110 through the lens 112 which bends the light toward the sensor array 116, passes through the control mechanism 114, and then reaches a sensor array 116. When the image sensor is activated to capture a scene, the control mechanism 114 opens a shutter to allow light to pass through to the sensor array 116. The control mechanism 114 includes an aperture and is synchronized with the operation of a mirror (e.g., a DLSR camera) or an electronic shutter (e.g., a mirrorless camera) to ensure accurate exposure and focus.

The control mechanism 114 may control exposure, focus, and/or zoom based on information from the image sensor 110 and/or based on information from the ISP 120. The control mechanism 114 may include multiple mechanisms and components such as focal control, exposure control, and/or zoom control. The one or more control mechanisms 114 may also include additional control mechanisms besides those that are illustrated, such as control mechanisms controlling analog gain, flash, high dynamic range (HDR), depth of field, and/or other image capture properties.

In some cases, additional lenses may be included in the image sensor 110, such as a telephoto lens, a wide-angle lens, and an ultrawide lens. In some cases, the image sensor 110 can include one or more microlenses over each photodiode of the sensor array 116. The microlenses bend the light received from the lens 112 toward the corresponding photodiode before the light reaches the photodiode. The focus setting may be determined via contrast detection autofocus (CDAF), phase detection autofocus (PDAF), or some combination thereof. The focus setting may be referred to as an image capture setting and/or an image processing setting.

The image sensor 110 includes a sensor array 116 including one or more arrays of photodiodes or other photosensitive elements. For example, the sensor array 116 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

Each photodiode in the sensor array 116 measures an amount of light that is incident to the photodiode during the exposure period and can be converted into an analog value by the sensor array 116. The amount of luminance captured in each photodiode directly corresponds to the exposure settings (e.g., the aperture and the exposure length). The process of measuring the values of the sensor array 116 is referred to as a readout and provides values corresponding to the luminance and the readout process can be controlled based on an address or other information provided to the image sensor 110. The image sensor 110 can perform a binning process to bin the quad-color filter array pattern into a binned pattern. The binning process increases the signal-to-noise ratio (SNR), which increases sensitivity and reduces noise in the captured image. In one example, binning can be performed in low-light settings when lighting conditions are poor to generate a high-fidelity image with higher brightness characteristics and less noise. Binning may also be performed on a high-photodiode count array, such as an image sensor with 48 megapixels (MP), to produce high-fidelity images.

In some cases, different photodiodes may be covered by different color filters of a color filter array to measure light matching the color of the color filter covering the photodiode. Non-limiting examples of color filter arrays include a Bayer color filter array, a quad-color filter array (also referred to as a quad Bayer filter), and/or other color filter array. Other types of color filter arrays may use yellow, magenta, and/or cyan (e.g., emerald) color filters instead of or in addition to red, blue, and/or green color filters. Some image sensors may lack color filters altogether and may instead use different photodiodes throughout the pixel array (in some cases vertically stacked). The different photodiodes throughout the pixel array can have different spectral sensitivity curves and may respond to different wavelengths of light. Monochrome image sensors may also lack color filters and therefore lack color depth.

The image sensor 110 may include opaque and/or reflective masks that block light from reaching some photodiodes at certain times and/or from certain angles, which the image sensor 110 can use to implement PDAF. The image sensor 110 may also include an analog gain amplifier to amplify the analog signals output by the photodiodes and an analog-to-digital converter (ADC) 118 to convert the analog signals output of the photodiodes into digital signals.

The ISP 120 is configured to control the image sensor 110 based on various controls and user control and may include one or more processors. In one example, the ISP 120 may be a digital signal processor (DSP) and/or other type of processor and may process images in a non-volatile memory, a memory, a cache, or some combination thereof. In some cases, the ISP 120 may be implemented into a system-on-chip (SoC), such as the SoC 140, and connected to various other processing cores. The ISP 120 is illustrated as separate from the SoC 140 for illustrative purposes only.

The ISP 120 may include a front-end 122 that provides an initial stage of processing that occurs to manipulate raw image sensor data captured by a camera. For example, the front end performs tasks such as demosaicing (e.g., converting raw sensor data into full-color images), color correction, sharpening filters, denoising filters, white balance adjustment, noise reduction, lens distortion correction, color space conversion, downsampling, pixel interpolation, automatic exposure (AE) control, automatic gain control (AGC), CDAF, PDAF, and forming an HDR image by merging of multiple exposures of a scene, etc.

The ISP 120 may also include an offline engine 124, which refers to image processing that occurs after the raw sensor data has been captured and initially processed. The offline engine 124 may be integral into the ISP 120 itself or may be a software pipeline. The offline engine may use computationally intensive algorithms and techniques for advanced image enhancement, feature extraction, object recognition, or other tasks that require deeper analysis of the image data. For example, the offline engine 124 may be integrated into an Application Programming Interface (API) and activated based on software instructions. For example, the offline engine 124 may perform object detection within an image to detect a person and detect the orientation of the person's face with respect to a camera. An example of an API implementing at least part of the offline engine 124 includes the Apple® VisionKit API. The offline engine 124 may use external assets such as a central processing unit (CPU), a graphics processing unit (GPU), and a neural engine (e.g., a neural processing unit (NPU)). For example, the offline engine 124 may use a neural engine 148 of the SoC 140 to perform object detection and other vision-related tasks.

The ISP 120 may also include capture controls 126 for controlling various aspects of the image sensor 110. For example, the capture controls 126 can include an exposure control 128, a focus control 130, a zoom control 132, and a strobe control 134. The controls 126 can include other types of control such as using external information to further control the image sensor 110, a flash control, and other types of controls for the image sensor 110. For example, the ISP 120 may receive luminance information from an external luminance sensor (not shown) to control the exposure.

The exposure control 128 can obtain an exposure setting and control the control mechanism 114 to affect the image capture. For example, the exposure control 128 can control a size of the aperture (e.g., aperture size or f-stop), a duration of time for which the aperture is open (e.g., exposure time or shutter speed), a sensitivity of the image sensor 110 (e.g., ISO speed or film speed), analog gain applied by the image sensor 110, or any combination thereof. The exposure setting may be referred to as an image capture setting and/or an image processing setting.

The focus control 130 can obtain or determine a focus setting and adjust the position of the lens 112 relative to the position of the sensor array 116. For example, based on the focus setting, the focus control 130 can move the lens 112 closer to the sensor array 116 or farther from the sensor array 116 by actuating a motor or servo and adjusting a focus.

The zoom control 132 can obtain or determine a zoom setting and control a focal length of an assembly of lens elements (lens assembly) that includes the lens 112 and one or more additional lenses. For example, the zoom control 132 can control the focal length of the lens 112 by actuating one or more motors or servos to move one or more of the lenses relative to one another. The zoom setting may be referred to as an image capture setting and/or an image processing setting.

The strobe control 134 allows the electronic device 100 (or the user) to adjust the frequency and intensity of the flash (e.g., using a light emitting diode (LED)) on their device when capturing content. The strobe control 134 customizes various parameters associated with a strobe effect to improve lighting conditions. Non-limiting examples of adjustable parameters include a flash frequency, flash duration, brightness, color temperature, and so forth to achieve desired lighting effects.

The SoC 140 is a semiconductor device that is manufactured and configured to include various components to integrate functions within the SoC to reduce delays associated with external interfaces and other impediments. For example, the SoC 140 may include a bus 142 to facilitate efficient communication between various components within the SoC 140. In some examples, the bus 142 can include a 192-bit or 256-bit path to optimize data flow and provide a low-latency and high bandwidth data path between the various components described below.

In one aspect, the SoC 140 may include a CPU 144 configured to execute arithmetic and logic software instructions. In some aspects, the CPU 144 comprises a plurality of processing cores that may be configured to execute the functionality in parallel, and the processing cores may have different configurations. For example, the CPU 144 may include a plurality of performance cores for low-latency functions and a plurality of efficiency cores that consume less power than the performance cores. The variety of cores enables the SoC 140 to parallelize tasks in an efficient manner to ensure seamless operation of the various elements.

The SoC 140 may also include a GPU 146 that is configured for various graphics operations and visualization. For example, a GPU 146 may include a plurality of graphics processing cores for specialized processing such as floating-point math. In some cases, the GPU 146 can be designed by a third-party vendor and integrated into the SoC 140 using semiconductor manufacturing techniques. The GPU uses relevant data, such as vertices and textures, and processes the data in the graphic processing cores for parallel execution. In some cases, the graphics processing cores may also be referred to as shader cores. The graphics cores each perform complex mathematical computations such as vertex transformations, rasterization, fragment shading, and texture mapping to generate the final pixels of the rendered image, which may be displayed by the electronic device 100. The GPU 146 is optimized for floating point and vector mathematical operations such as warping, image analysis, and so forth.

The SoC 140 includes a neural engine 148 that includes a plurality of neural processing cores. A neural processing core includes arrays of multiply-accumulate (MAC) units and specialized instructions that are optimized for matrix operations, such as convolution and matrix multiplication. A neural processing core receives input data and performs matrix transformations and nonlinear activation functions to break down and parallelize matrix operations. The neural processing core is configured to perform tasks such as inference (e.g., runtime operation of an ML model) or training of deep learning models. For example, the neural engine 148 may perform computer vision tasks such as object recognition.

The SoC 140 may also include one or more accelerated processing units that are configured to perform specific functions. For example, the SoC 140 may include DSPs, motion sensing co-processors, video encoders and decoders, network co-processors, wireless communication modules, and so forth. As noted above, the SoC 140 may also include the ISP 120, and the ISP 120 is illustrated separately for the purpose of illustration only.

In some aspects, the SoC 140 may also include a shared memory 150 such as a random access memory (RAM) that is shared between the various components (e.g., CPU 144, GPU 146, neural engine 148, etc.). The SoC 140 may include additional hardware and software components to streamline memory allocation between the different components within the SoC 140.

The SoC 140 may also include a secure enclave 152 that is configured to secure the SoC 140 using various encryption techniques. The secure enclave may include encryption generation functionality, a true random number generator, a secure storage medium, and so forth. An example of a secure enclave 152 is a TPM module. In some cases, the SoC 140 or the secure enclave 152 may also be configured to interface with a security sub-system (not shown), such as a security module that is configured to securely store information that is not made available to the SoC 140. In one aspect, the security sub-system may securely store biometric information to enable various functions such as biometric authentication, etc.

The SoC 140 also includes a fabric 154 that is configured to facilitate interfacing the components of the SoC 140 internally and externally. As an example, the fabric 154 may include functionality to allocate the shared memory 150 between the various components within the SoC 140. The SoC 140 may interconnect the various components using a bus to enable access to the various components, such as enabling the CPU 144 to address a portion of the shared memory 150. In some aspects, the fabric 154 may also interface with external components such as a security sub-system, various bus interfaces (e.g., Peripheral Component Interconnect Express (PCI-e), thunderbolt, universal serial bus, a communication circuit for wireless communication, and so forth).

The SoC 140 may also include a video codec 156 (e.g., a video encoder and decoder) to encode raw video data and decode the encoded data for playback. The video codec 156 may be a hardware device due to increased efficiency, performance, power consumption, and advanced algorithms. In addition, hardware codecs ensure compatibility with a wide range of multimedia formats and standards to provide seamless playback and interoperability across different devices, applications, and services.

The SoC 140 can also include a motion processor 158 for interfacing with motion sensors. The motion processor 158 is configured to collect, process, and analyze data from various motion sensors, including accelerometers, gyroscopes, magnetometers, and sometimes barometers. The motion processor 158 is configured to continuously monitoring motion and orientation data to accurately detect changes in device orientation, track movement patterns, and enable features such as step counting, activity recognition, gesture control, and augmented reality experiences. The motion processor 158 includes dedicated hardware that is configured to run with ultra-low power consumption and continually monitor and record data from the various sensors.

While the electronic device 100 is shown to include certain components, one of ordinary skill will appreciate that the electronic device 100 can include more components than those shown in FIG. 1. The components of the electronic device 100 can include software, hardware, or one or more combinations of software and hardware. For example, in some implementations, the components of the electronic device 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device 100.

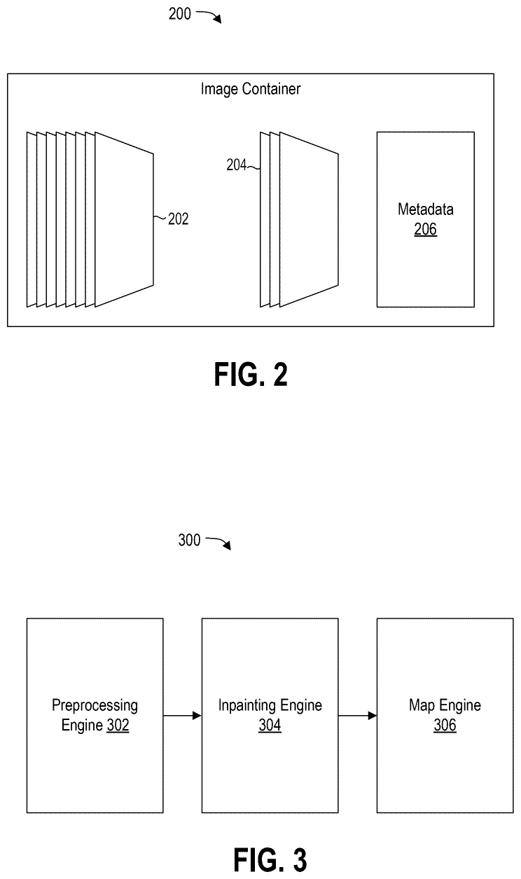

FIG. 2 is a conceptual diagram of an image container in accordance with some examples. An image container 200 is a digital file format that encapsulates at least one image 202, auxiliary data, and metadata 206 within a single file. The image container 200 includes various components of an image, including the pixel data, color profiles, thumbnails, and other descriptive information. An example of an image container is the high efficiency image format (HEIC) is a file format developed by the MPEG group, specifically designed to store images efficiently.

In some aspects, a HEIC uses advanced compression algorithms such as HEVC (High Efficiency Video Coding) to improve compression while maintaining high image quality. This is especially beneficial for storing large collections of images without consuming excessive storage space. HEIC also supports features for high-quality images such as 16-bit color depth, transparency, and lossless compression. HEIC supports storing multiple images within a single file, along with metadata to provide storage for different types of photos, such as burst photos, image sequences, still images, animated sequences, image sequences with alpha channels, and related image data.

For example, the image container 200 stores and organizes at least one image 202 and provides advanced features based on the auxiliary image 204 and the metadata 206. The image container 200 may support advanced features like compression, encryption, and embedded scripting for versatile usage with a wide range of applications, from digital photography to multimedia production. Image containers may also include the ability for non-destructive manipulation that changes the image based on additional metadata, preserving the original content within the image container 200.

The image container 200 may also store at least one auxiliary image 204 for supplementing the images. Non-limiting examples of an auxiliary image 204 include a gain map, a depth map, a normal map, a specular map, ambient occlusion map, an opacity map, an albedo map, a metallic map, an emission map, a height map, and so forth. A gain map, also referred to as a gain image or a gain mask, is a two-dimensional representation used in image processing to adjust the brightness or contrast of an image selectively across different regions. Each pixel of a gain map contains a value representing the amount of gain or adjustment to be applied to the corresponding pixel in the original image. Gain maps are commonly used in techniques such as local tone mapping and enable fine-tuned control over the exposure and contrast in specific areas of an image. By varying the gain values across the image, photographers and digital artists can enhance details, improve dynamic range, and achieve desired aesthetic effects while preserving overall image quality. Gain maps are particularly useful in HDR imaging, where scenes contain a wide range of luminance values that need to be mapped to the limited dynamic range of display devices.

A depth map, also referred to as a depth image or a depth mask, is a two-dimensional representation of the spatial depth information present in a scene and assigns each pixel a value that corresponds to its distance from the camera or observer. Darker areas of a depth map indicate objects closer to the viewer and lighter areas represent objects farther away. Depth maps are commonly used in various applications, such as photography, computer vision, and augmented reality, to enable effects like depth-of-field adjustments, three-dimensional (3D) reconstruction, object segmentation, and virtual object placement.

The image container 200 is beneficial for non-destructive modifications, retouching, and various techniques to improve the content. For example, ML models can be used to segment the different objects in the foreground, identify objects within the image 202, and so forth.

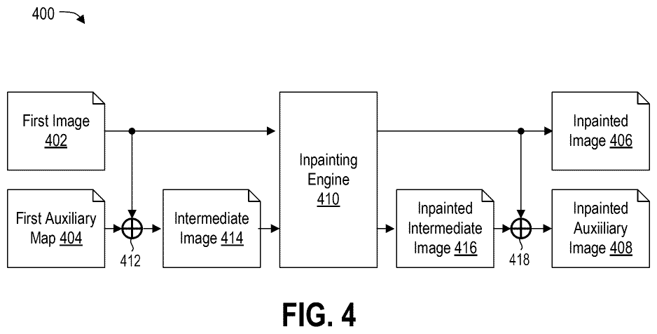

FIG. 3 is a conceptual block diagram of an inpainting system 300 for inpainting an image in accordance with some examples. For example, the inpainting system 300 may be configured to inpaint an image based on combining an auxiliary image with an image (e.g., a standard dynamic range (SDR) image, an HDR image, etc.).

The inpainting system 300 includes a preprocessing engine 302 to perform one or more modifications to an image or identify information pertaining to a difference between two images. For example, the preprocessing engine 302 may be configured to merge different images prior to inpainting into an intermediate image. In another example, the preprocessing engine 302 may be configured to identify a transformation between two different images and the transformation can be used based on a single inpainting.

An inpainting engine 304 is configured to receive the images and is configured to inpaint a single image. In some aspects, the inpainting engine 304 may be a generative ML model to generate (or hallucinate) content based on a context of the image. For example, the generative ML model can be trained based on various frameworks (e.g., PyTorch, Style Engine, etc.) and enable the generative ML model to create content based on input images. For example, inpainting can be used to generate new content in the foreground or background. Generative ML models are stochastic in nature and can significantly deviate based on input. For example, inputting an SDR image (e.g., an image having a color depth of 8 bits) and an HDR image (e.g., an SDR image combined with a gain map) to inpaint may yield different results, in addition to consuming a significant amount of processing time and power.

In this case, the inpainting engine 304 is configured to inpaint images in conjunction with an auxiliary image or other data that also provides corresponding content to auxiliary images. For example, the inpainting engine 304 may remove an object in the background (e.g., a white vent on a wall) in an image. Based on the different techniques described below, the inpainting engine 304 may also generate an auxiliary image (e.g., a gain map, a depth map, etc.) to improve visual fidelity. A gain map can be used to provide specular highlights to improve the dynamic range and the visual fidelity. In one example, a depth map may be used in a stereoscopic vision system to improve separation from stereo displays and improve visual fidelity. The depth map also can be used for other purposes, such as autonomous navigation.

A segmenting-based approach (e.g., by separating different objects in the scene) may not be appropriate for inpainting because different objects within the scene, including the background, may have luminance elements. For example, a sign in the background may emit luminance, and segmenting would remove all highlights applied to any background objects while preserving highlights to foreground objects, reducing the visual fidelity.

In one illustrative aspect, the inpainting engine 304 may be configured to inpaint an intermediate image, which is formed based on combining an image (e.g., an SDR image or an HDR image) with an auxiliary image (e.g., a gain map, a depth map, etc.). In another illustrative aspect, the inpainting engine 304 may be configured to inpaint an unmodified SDR image or an unmodified HDR image (e.g., an inpainted image).

The inpainting system 300 also includes a map engine 306 that is configured to generate an inpainted image based on the inpainted intermediate image or the inpainted image. In some cases, the map engine 306 may also generate an auxiliary image (e.g., a gain map, a depth map, etc.) based on the inpainted intermediate image based on subtractive synthesis techniques. For example, an inpainted intermediate image (the intermediate image inpainted with content) includes a combination (e.g., a blend ratio) of image content and a gain map, and subtracting the original image from the inpainted intermediate image yields the inpainted auxiliary image. Further aspects and details of the inpainting system 300 are further described below.

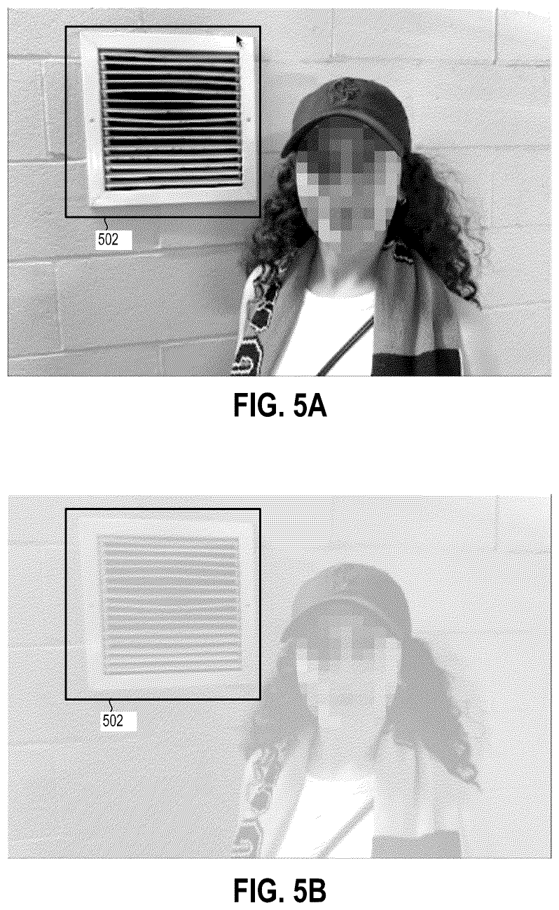

FIG. 4 is a block diagram of an inpainting system 400 for inpainting based on subtractive synthesis in accordance with some examples. In the inpainting system 400, a first image 402 and a first auxiliary image 404 associated with the first image (e.g., a gain map of the first image 402, a depth map, etc.) are provided to an inpainting engine 410 (e.g., the inpainting engine 304 in FIG. 3) to generate an inpainted image 406 and an inpainted auxiliary image 408.

The inpainting engine 410 is configured to generate content based on selected content within the first image 402 and fill in the selected content in the inpainted image 406. In this case, the first image 402 can be an SDR image or an HDR image. In some cases, the user selects the undesirable content for the inpainting engine 410 to remove. For example, the user may identify an object using a segmenting engine (e.g., an ML model) to remove content from the image. Based on the selected content, the inpainting engine 410 is trained to remove the undesirable content and generate content that seamlessly blends into the first image 402.

The first image 402 and the first auxiliary image 404 are combined into an intermediate image 414 via an adder 412 (e.g., the preprocessing engine 302 of FIG. 3). In some examples, the adder 412 is configured to blend the images the first image 402 and the first auxiliary image 404 based on a ratio. The ratio may be fixed (e.g., 50:50) or may be dynamic (e.g., based on a qualitative analysis of the first image 402 and/or the first auxiliary image 404). The intermediate image 414 (also referred to as a blended image) is also provided to the inpainting engine 410, which generates an inpainted intermediate image 416.

In some cases, the inpainting engine 410 may be trained based on a substantial amount of the training images that are various combinations of images and auxiliary images (e.g., combined based on a ratio as described above). In this case, the inpainting engine 410 learns to inpaint unmodified images (e.g., the first image 402) or blended images (e.g., the 414), and validation and other reinforcement techniques can cause the inpainting engine 410 to apply highly correlated modifications based on a blend of the images.

The inpainted intermediate image 416 is provided to an adder 418 (e.g., the map engine 306 in FIG. 3) to perform subtractive synthesis. In this case, the inpainted intermediate image 416 is highly correlated to the inpainted image 406 based on training the inpainting engine 410 to inpaint on both unmodified images and blended images. The adder 418 is configured to subtract the inpainted image 406 from the inpainted auxiliary image, which results in the inpainted auxiliary image 408. In this example, the inpainting engine 410 is configured to blend an image and a corresponding image in connection with creating an auxiliary image based on the relationship between the first image and the first auxiliary image 404.

In some aspects, the various processes described in connection with the inpainting system 400 may be performed in a GPU (e.g., the GPU 146 in FIG. 1). For example, the GPU parallelizes the various operations described above in an efficient manner. The ML model may be configured to execute in the GPU, but can also be operated in a neural engine (e.g., the neural engine 148 in FIG. 1).

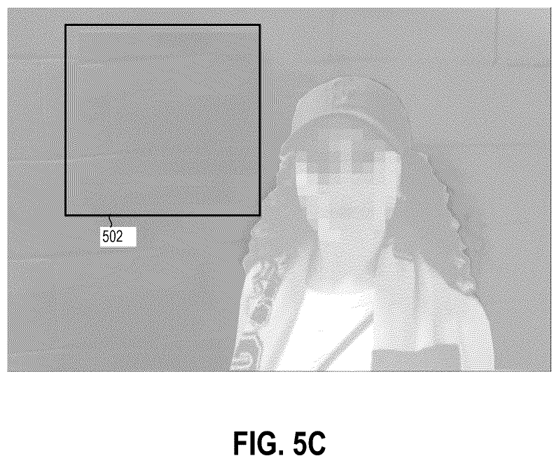

FIGS. 5A to 5C illustrate examples of content used in connection with the inpainting system 300 (e.g., the inpainting system 400 of FIG. 4) in accordance with some examples. FIG. 5A is an SDR image of a person positioned near a background object 502. As shown in FIG. 5A, the background object 502 is painted white. FIG. 5B illustrates an original gain map (e.g., an auxiliary image) of the image in FIG. 5A. In particular, FIG. 5B shows that the background object 502 is white and, as a result, an extended HDR display will increase the brightness of the background object 502 when displayed. FIG. 5C illustrates an inpainted auxiliary image (e.g., the inpainted auxiliary image 408 of FIG. 4) with the background object 502 now inpainted with pixels corresponding to an inpainted image. In this case, when the inpainted image is displayed, the enhancements provided by the inpainted auxiliary image increase the visual fidelity while omitting content that is undesirable.

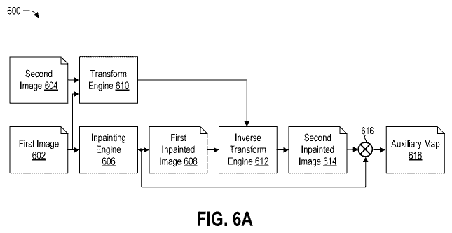

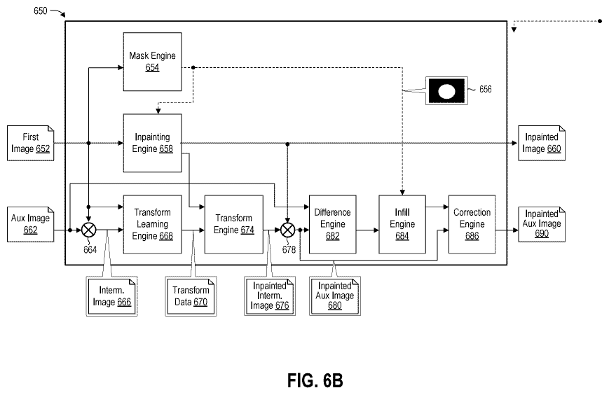

FIG. 6A is a block diagram of an inpainting system for inpainting based on transformation mapping in accordance with some examples.

In the inpainting system 600, a first image 602 and a second image 604 associated with the first image have a relationship. For example, the first image 602 and the second image 604 are correlated through a gain map. In this example, one of the first image 602 and the second image 604 is an SDR image and the other is an HDR image.

The first image 602 is provided to an inpainting engine 606 to inpaint undesirable content. For example, a user may select a particular object to remove in the image. The inpainting engine 606 is configured to inpaint over the undesirable content and generate a first inpainted image 608.

The first image 602 and the second image 604 are also provided to a transform engine 610 (e.g., the preprocessing engine 302) that is configured to identify other types of transformation between local regions within the first image 602 and the second image 604. For example, the transform engine 610 divides each of the first image 602 and the second image 604 into a different pixel region (e.g., a 32×32 pixel region) and identifies a transformation that maps the region from the first image 602 to the second image 604 (or the second image 604 to the first image 602). Examples of transformations include a local tone curve, a transformation matrix, a non-linear transformation determined by a generative ML model, or another type of transformation. The transform engine 610 generates the corresponding transform for each different pixel region and generates transformation information.

The first inpainted image 608 and the transformation information (e.g., from the transform engine 610) are provided to an inverse transform engine 612, which applies an inverse transformation to the first inpainted image 608 to generate a second inpainted image 614. In this case, the transformations from the first image 602 and the second image 604 are applied to the first inpainted image 608, thereby causing an equivalent transformation to inverse transform engine 612. In this case, one of the first inpainted image 608, and the second inpainted image 614 is an SDR image with inpainted content and the other is an HDR image with inpainted content.

The first inpainted image 608 and the second inpainted image 614 may be provided to a multiplier 616, which is configured to divide the first inpainted image 608 and the second inpainted image 614 to generate an inpainted auxiliary map 618. For example, by dividing the first inpainted image 608 and the second inpainted image 614, a ratio of the brightness between the images is determined (e.g., a gain map).

The use of locally guided transformations between the first image 602 and the second image 604 may provide more detailed information and provide better detail in some cases. In addition, a single inpainting is required in this case.

FIG. 6B is another block diagram of an inpainting system 650 for inpainting based on transformation mapping in accordance with some examples.

In some aspects, a first image 652 is provided to a mask engine 654 that is configured to generate a mask 656 based on content to inpaint. For example, a user can select a region (e.g., the background object 502 in FIG. 5A) to request removal and the mask engine 654 generates a corresponding mask 656 to identify the region.

The first image 652 (e.g., the image 202 in FIG. 2) is also provided to an inpainting engine 658 to inpaint over undesirable content based on the mask 656 to generate an inpainted image 660. In some aspects, the inpainting engine 658 may be a generative ML model that is configured to remove undesirable content from the first image 652 by seamlessly filling the removed area with contextually appropriate content (in the inpainted image 660). The inpainting engine 658 may be configured based on a deep learning models trained on large image datasets, such as diffusion models or GANs generative adversarial networks (GANs) and learn to understand surrounding pixels and generate realistic replacements.

In some aspects, the first image 652 may also have a corresponding auxiliary image 662 (e.g., the auxiliary image 204 in FIG. 2), such as a gain map, a depth map, and so forth. The inpainting system 650 includes a combiner 664 that is configured to combine the first image 652 and the auxiliary image 662 into an intermediate image 666. For example, the combiner 664 is configured to perform various operations to combine the first image 652 and the auxiliary image 662 to produce an image with richer data. For example, if the auxiliary image 662 includes gain data, the intermediate image 666 corresponds to an HDR image.

The inpainted image 660 includes a transform learning engine 668 that is configured to learn a transformation based on the first image 652 and the intermediate image 666. The transform learning engine 668 may be configured to learn the transform over the entire image or a portion of the image (e.g., using the mask 656). In some aspects, the transform learning engine 668 can be configured using ML techniques to learn the visual transformation from the first image 652 to the intermediate image 666 using various optical differences, such as bright and reflective regions. The transform learning engine 668 is configured to generate transform data 670 that relates the mapping form the first image 652 to the auxiliary image 662 in weights that are understandable by the ML engine.

The inpainting system 650 also includes a transform engine 674 that receives the generate transform data 670 and the inpainted image 660, and then applies to transformation in the generate transform data 670 to the inpainted image 660. In this way, the transform engine 674 applies the learned transformation in the generate transform data 670 based on the content in the inpainted image 660 to generate an inpainted intermediate image 676. For example, if the intermediate image 666 correspond to an HDR based on the auxiliary image 662 including gain data, the inpainted intermediate image 676 corresponds to an HDR version of the inpainted image 660. During the transformation by the transform engine 674, the transform engine 674 applies transform data in the first portion to modify the inpainted pixels based on similar pixels in the first image, and in this way can remove features from the auxiliary image 662 that were removed from the inpainted image 660.

The inpainting system 650 includes a combiner 678 and uses the inpainted intermediate image 676 and the inpainted image 660 to generate an inpainted auxiliary image 680. For example, the inpainted auxiliary image 680 may be a gain map but with the removed undesirable content and its image property (e.g., specular highlights from metallic objects) replaced with corresponding content of the inpainted region. In this case, the inpainted auxiliary image 680 more accurately represents the inpainted content and the visual fidelity of the inpainted image 660 is improved based on removing corresponding content in the auxiliary image 662 by learning the visual transformation, and then applying the learned transformation into the inpainted region 656.

In some cases, the inpainted auxiliary image 680 can be further processed to improve visual fidelity. For example, the inpainted auxiliary image 680 may have various artifacts present at edges of the inpainted region. In some aspects, the inpainting system 650 can include additional processing to improve the visual fidelity. For example, the inpainted auxiliary image 680 may be provided to a difference engine 682 to compute a difference between the inpainted auxiliary image 680 and the first image 602. The difference generated by the difference engine 682 may be provided to an infill engine 684 to infill a region based on the mask 656. For example, the infill engine is configured to filling the difference image with a smooth and fast infill algorithm to reduce visual artifacts that may be present in the auxiliary image. The inpainted difference and the inpainted auxiliary image 680 are input into a correction engine 686 to combine and generate a seamless inpainted auxiliary image 690. In this case, the additional post processing to generate a seamless inpainted auxiliary image 690 addresses visual artifacts and produces an auxiliary image that matches the inpainted image 660. For example, the additional infill and blending corrects a boundary region and ensures that there are no visible artifacts in the boundary region around the inpainted area.

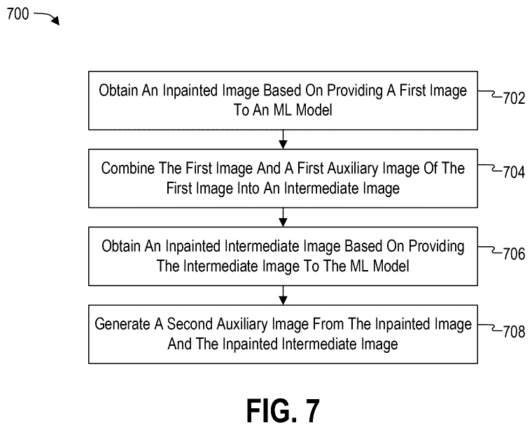

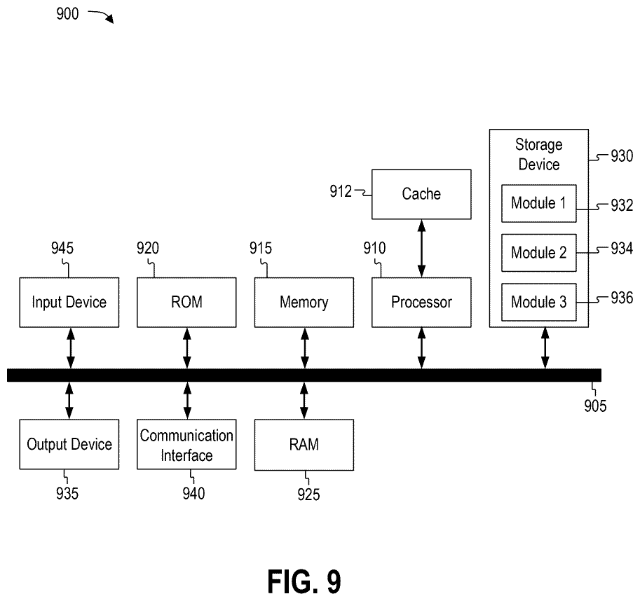

FIG. 7 is a flowchart illustrating an example process 700 for inpainting images and auxiliary images in accordance with some examples. The process 700 can be performed by a computing device (or apparatus) or a component (e.g., a chipset, codec, etc.) of the computing device. In some aspects, the computing device may include an ISP. The computing device may be a mobile device (e.g., a mobile phone), a network-connected wearable such as a watch, an XR device (e.g., a VR device or AR device), a vehicle or component or system of a vehicle, or other types of computing device. The operations of the process 800 may be implemented as software components that are executed and run on one or more processors (e.g., CPU 144, GPU 146, Neural Engine 148 of FIG. 1, the processor 910 of FIG. 9, or other processor(s)). Further, the transmission and reception of signals by the computing device in the process 800 may be enabled, for example, by one or more antennas, one or more transceivers (e.g., wireless transceiver(s)), and/or other communication components of the computing device.

At block 702, the computing system may obtain an inpainted image based on providing a first image to an ML model. In some cases, the first image may be an SDR image or an HDR image. For example, the first image and additional data (e.g., identification of a pixel region to inpaint) may be input into a generative ML model. The generative ML model removes a portion of content in the first image, insert pixels generated during inference into the removed portion, and outputs the inpainted image. The ML model (e.g., the generative ML model) is trained based on a blended image dataset having a portion of images that are blended with corresponding auxiliary image data.

At block 704, the computing system may combine the first image and a first auxiliary image of the first image into an intermediate image. In this case, the first auxiliary image may be a gain map having gain data of corresponding pixels to the first image. In other cases, the first depth map, or other auxiliary image as described above.

At block 706, the computing system may obtain an inpainted intermediate image based on providing the intermediate image to the ML model. For example, the ML model receives the intermediate image and the additional data (e.g., identification of a pixel region to inpaint). The generative ML model removes a portion of content in the intermediate image, inserts pixels generated during inference into the removed portion, and outputs the inpainted intermediate image. In this case, the ML model (e.g., the generative ML model) is trained based on a blended image dataset, the ML model is configured to generate substantially similar content based on the image being unblended or blended. Substantially similar content in this context is content that has high visual fidelity and based on a cursory inspection has a very high correlation.

At block 708, the computing system may generate a second auxiliary image from the inpainted image and the inpainted intermediate image. For example, the computing system may subtract the inpainted image from the inpainted intermediate image, resulting in the inpainted auxiliary image.

The inpainted image and the inpainted auxiliary image may be stored in an image container (e.g., an HEIC file) or another storage mechanism to allow the inpainted image and the inpainted auxiliary image to be displayed together. For example, when the inpainted image is displayed by a display panel of the device, the device or the display panel is configured to apply gain of pixels in the inpainted auxiliary image to corresponding pixels in the inpainted image and apply highlights and increase the visual fidelity of the displayed inpainted image. In another example, the inpainted auxiliary image may be a depth map displayed in an XR device is to generate display information for stereoscopic displays (e.g., a left image, a right image) in increase the visual fidelity.

In this case, the ML model learns to handle unblended content (e.g., an original image) and blended content (e.g., an original image blended with a corresponding auxiliary image) in the same manner and resulting in inpainted content with a high correlation. Accordingly, the inpainted auxiliary image can be generated based on subtractive synthesis of the inpainted image and the inpainted auxiliary image.

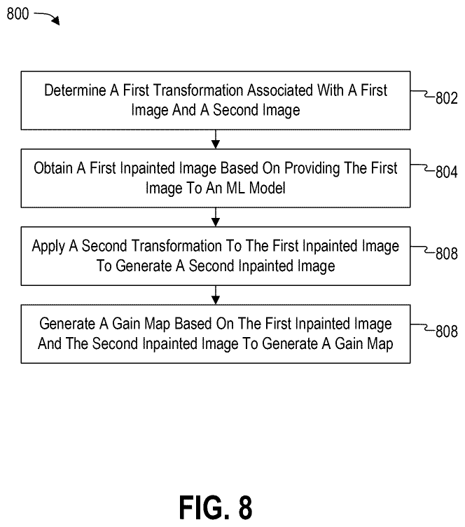

FIG. 8 is a flowchart illustrating an example process 800 for inpainting images and auxiliary images in accordance with some examples. The process 800 can be performed by a computing device (or apparatus) or a component (e.g., a chipset, codec, etc.) of the computing device.

At block 802, the computing system may determine a first transformation associated with a first image and a second image. In this example, one of the first images and the second image may be an SDR image and the other may be an HDR image. As part of block 802 to determine the first transformation, the computing system may divide the first image and the second image into corresponding portions (e.g., a 32×32 pixel region) and determine a local transformation for each corresponding portion to cause the portion of the first image to be substantially equal to the portion of the second image. Non-limiting examples of the first transformation comprise at least one of a local tone curve, a transformation matrix, or a non-linear transformation determined by a generative ML model.

At block 804, the computing system may obtain a first inpainted image based on providing the first image to an ML model. In some aspects, the ML model is configured to generate pixels from the first image and then insert the generated pixels into the first inpainted image, thereby removing undesirable content.

At block 806, the computing system may apply a second transformation to the first inpainted image to generate a second inpainted image. In one example, the second transformation is an inverse of the first transformation.

At block 808, the computing system may also generate a gain map based on the first inpainted image and the second inpainted image to generate a gain map. For example, the gain map is generated based on dividing the first inpainted image and the second inpainted image, and the remainder yields the gain map.

In some cases, the computing system may also store one of the first inpainted images or the second inpainted image and the gain map, for example, in an HEIC file. The computing system may also display the SDR version of the inpainted image with the gain map. For example, when the second image comprises 8-bit depth, the device or the display panel is configured to apply gain of pixels in the gain map to corresponding pixels in the second image, thereby increasing luminance of highlight regions and darkening shadow regions.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive IP-based data or other type of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

The process 700 and the process 800 are illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 700 and/or any other process described herein (e.g. process 800) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a diagram illustrating an example of a system for implementing certain aspects of the present technology. In particular, FIG. 9 illustrates an example of computing system 900, which may be for example any computing device making up internal computing system, a remote computing system, a camera, or any component thereof in which the components of the system are in communication with each other using connection 905. Connection 905 may be a physical connection using a bus, or a direct connection into processor 910, such as in a chipset architecture. Connection 905 may also be a virtual connection, networked connection, or logical connection.

In some embodiments, computing system 900 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 900 includes at least one processing unit (CPU or processor) 910 and connection 905 that communicatively couples various system components including system memory 915, such as ROM 920 and RAM 925 to processor 910. Computing system 900 may include a cache 912 of high-speed memory connected directly with, in close proximity to, or integrated as part of processor 910.

Processor 910 may include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which may represent any number of input mechanisms, such as a microphone for speech, a touch-sensitive screen for gesture or graphical input, keyboard, mouse, motion input, speech, etc. Computing system 900 may also include output device 935, which may be one or more of a number of output mechanisms. In some instances, multimodal systems may enable a user to provide multiple types of input/output to communicate with computing system 900.

Computing system 900 may include communications interface 940, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 may include software services, servers, services, etc., that when the code that defines such software is executed by the processor 910, it causes the system to perform a function. In some embodiments, a hardware service that performs a particular function may include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Illustrative aspects of the disclosure include:

Aspect 1. A computing device for processing images. The computing device includes at least one memory and at least one processor coupled to the at least one memory and configured to: obtain an inpainted image based on providing a first image to an ML model; combine the first image and a first auxiliary image of the first image into an intermediate image; obtain an inpainted intermediate image based on the intermediate image; and generate a second auxiliary image from the inpainted image and the inpainted intermediate image.

Aspect 2. The computing device of Aspect 1, wherein inpainted content in the inpainted image and the inpainted intermediate image are correlated based on training associated with a machine learning (ML) model.

Aspect 3. The computing device of Aspect 2, wherein the ML model is configured to receive identification of content in the first image to inpaint into the inpainted image and the inpainted intermediate image.

Aspect 4. The computing device of any of Aspects 2 to 3, wherein the ML model is trained based on a blended image dataset having a portion images that are blended with corresponding auxiliary image data.

Aspect 5. The computing device of any of Aspects 2 to 4, wherein the ML model is configured to remove a portion of content in the first image and insert pixels generated during inference.

Aspect 6. The computing device of any of Aspects 1 to 5, wherein the first auxiliary image and the second auxiliary image includes gain data of corresponding pixels.

Aspect 7. The computing device of any of Aspects 1 to 6, wherein generating the second auxiliary image comprises subtracting the inpainted image from the inpainted intermediate image.

Aspect 8. The computing device of any of Aspects 1 to 7, wherein the second auxiliary image is generated based on subtracting the first image from the inpainted image.

Aspect 9. The computing device of any of Aspects 1 to 8, wherein, when the inpainted image is displayed by a display panel of the device, the device or the display panel is configured to apply gain of pixels in the second auxiliary image to corresponding pixels in the inpainted image.

Aspect 10. The computing device of any of Aspects 1 to 9, wherein the first auxiliary image and the second auxiliary image includes depth data identifying a distance of pixels from an image capture device.

Aspect 11. A method of processing images on a device, comprising: obtaining an inpainted image based on providing a first image to an ML model; combining the first image and a first auxiliary image of the first image into an intermediate image; obtaining an inpainted intermediate image based on the intermediate image; and generating a second auxiliary image from the inpainted image and the inpainted intermediate image.

Aspect 12. The method of Aspect 11, wherein inpainted content in the inpainted image and the inpainted intermediate image are correlated based on training associated with a machine learning (ML) model.

Aspect 13. The method of Aspect 12, wherein the ML model is configured to receive identification of content in the first image to inpaint into the inpainted image and the inpainted intermediate image.

Aspect 14. The method of any of Aspects 12 to 13, wherein the ML model is trained based on a blended image dataset having a portion images that are blended with corresponding auxiliary image data.

Aspect 15. The method of any of Aspects 12 to 14, wherein the ML model is configured to remove a portion of content in the first image and insert pixels generated during inference.

Aspect 16. The method of any of Aspects 11 to 15, wherein the first auxiliary image and the second auxiliary image includes gain data of corresponding pixels.

Aspect 17. The method of any of Aspects 11 to 16, wherein generating the second auxiliary image comprises subtracting the inpainted image from the inpainted intermediate image.

Aspect 18. The method of any of Aspects 11 to 17, wherein the second auxiliary image is generated based on subtracting the first image from the inpainted image.

Aspect 19. The method of any of Aspects 11 to 18, wherein, when the inpainted image is displayed by a display panel of the device, the device or the display panel is configured to apply gain of pixels in the second auxiliary image to corresponding pixels in the inpainted image.

Aspect 20. The method of any of Aspects 11 to 19, wherein the first auxiliary image and the second auxiliary image includes depth data identifying a distance of pixels from an image capture device.

Aspect 21. A computing device for processing images. The computing device includes at least one memory and at least one processor coupled to the at least one memory and configured to: determine a first transformation associated with a first image and a second image; obtain a first inpainted image based on providing the first image to an ML model; and apply a second transformation to the first inpainted image to generate a second inpainted image.

Aspect 22. The computing device of Aspect 21, wherein the second transformation is an inverse of the first transformation.

Aspect 23. The computing device of any of Aspects 21 to 22, wherein the at least one processor is configured to: divide the first image and the second image into corresponding portions; and determine a local transformation for each corresponding portion to cause the portion of the first image to be substantially equal to the portion of the second image.

Aspect 24. The computing device of any of Aspects 21 to 23, wherein the first transformation comprises at least one of a local tone curve, a transformation matrix, or a non-linear transformation determined by a generative ML model.

Aspect 25. The computing device of any of Aspects 21 to 24, wherein the at least one processor is configured to: generate a gain map based on the first inpainted image and the second inpainted image.

Aspect 26. The computing device of Aspect 25, wherein the gain map is generated based on dividing the first inpainted image and the second inpainted image.

Aspect 27. The computing device of any of Aspects 25 to 26, wherein, when the second image is displayed by a display panel of the device, the device or the display panel is configured to apply gain of pixels in the gain map to corresponding pixels in the second image.

Aspect 28. The computing device of any of Aspects 21 to 27, wherein the second image has a higher dynamic range than the first image.

Aspect 29. The computing device of any of Aspects 21 to 28, wherein the first image has a higher dynamic range than the second image.

Aspect 30. The computing device of any of Aspects 21 to 29, wherein the ML model is configured to generate pixels to insert into the first inpainted image to reduce a luminance of content in the first image or the second image.

Aspect 31. A method of processing images on a device, comprising: determining a first transformation associated with a first image and a second image; obtaining a first inpainted image based on providing the first image to an ML model; and applying a second transformation to the first inpainted image to generate a second inpainted image.

Aspect 32. The method of Aspect 31, wherein the second transformation is an inverse of the first transformation.

Aspect 33. The method of any of Aspects 31 to 32, wherein learning the first transformation comprises: dividing the first image and the second image into corresponding portions; and determining a local transformation for each corresponding portion to cause the portion of the first image to be substantially equal to the portion of the second image.

Aspect 34. The method of any of Aspects 31 to 33, wherein the first transformation comprises at least one of a local tone curve, a transformation matrix, or a non-linear transformation determined by a generative ML model.

Aspect 35. The method of any of Aspects 31 to 34, further comprising: generating a gain map based on the first inpainted image and the second inpainted image.

Aspect 36. The method of Aspect 35, wherein the gain map is generated based on dividing the first inpainted image and the second inpainted image.

Aspect 37. The method of any of Aspects 35 to 36, wherein, when the second image is displayed by a display panel of the device, the device or the display panel is configured to apply gain of pixels in the gain map to corresponding pixels in the second image.

Aspect 38. The method of any of Aspects 31 to 37, wherein the second image has a higher dynamic range than the first image.

Aspect 39. The method of any of Aspects 31 to 38, wherein the first image has a higher dynamic range than the second image.

Aspect 40. The method of any of Aspects 31 to 39, wherein the ML model is configured to generate pixels to insert into the first inpainted image to reduce a luminance of content in the first image or the second image.

Aspect 41. A computing device for processing images. The computing device includes at least one memory and at least one processor coupled to the at least one memory and configured to: inpaint a first portion of a first image to generate a first inpainted image; combine the first image with an auxiliary image to generate a first intermediate image; learn a transformation from the first image to the first intermediate image to generate transform data; apply the transform data to the first inpainted image to generate a second intermediate image; and combine the second intermediate image and the first inpainted image to generate an inpainted auxiliary image.

Aspect 42. The computing device of Aspect 41, wherein the at least one processor is configured to: receive an identification of the first region to inpaint over undesirable content based on user input.

Aspect 43. The computing device of any of Aspects 41 to 42, wherein a machine learning (ML) model is configured to learn the transformation and generate the transform data.

Aspect 44. The computing device of Aspect 43, wherein an ML model is configured to apply the transform data in the first portion based to modify inpainted pixels in the first portion based on similar pixels in the first image.

Aspect 45. The computing device of any of Aspects 41 to 44, wherein combining the second intermediate image and the first inpainted image comprises scaling pixels in the second intermediate image based on pixels from the first inpainted image.

Aspect 46. The computing device of any of Aspects 41 to 45, wherein combining the first image with an auxiliary image comprises scaling pixels in the first image based on pixels from the auxiliary image.

Aspect 47. The computing device of any of Aspects 41 to 46, wherein the first portion of the inpainted auxiliary image is substantially correlated to the first portion of the inpainted image.

Aspect 48. A method of processing images on a device, comprising: inpainting a first portion of a first image to generate a first inpainted image; combining the first image with an auxiliary image to generate a first intermediate image; learning a transformation from the first image to the first intermediate image to generate transform data; applying the transform data to the first inpainted image to generate a second intermediate image; and combining the second intermediate image and the first inpainted image to generate an inpainted auxiliary image.

Aspect 49. The method of Aspect 48, further comprising: receiving an identification of the first region to inpaint over undesirable content based on user input.

Aspect 50. The method of any of Aspects 48 to 49, wherein a machine learning (ML) model is configured to learn the transformation and generate the transform data.

Aspect 51. The method of Aspect 50, wherein an ML model is configured to apply the transform data in the first portion based to modify inpainted pixels in the first portion based on similar pixels in the first image.

Aspect 52. The method of any of Aspects 48 to 51, wherein combining the second intermediate image and the first inpainted image comprises scaling pixels in the second intermediate image based on pixels from the first inpainted image.

Aspect 53. The method of any of Aspects 48 to 52, wherein combining the first image with an auxiliary image comprises scaling pixels in the first image based on pixels from the auxiliary image.

Aspect 54. The method of any of Aspects 48 to 53, wherein the first portion of the inpainted auxiliary image is substantially correlated to the first portion of the inpainted image.

Aspect 55. A non-transitory computer-readable medium having stored thereon instructions that, when executed by at least one processor, cause the at least one processor to perform operations according to any of Aspects 11 to 20.

Aspect 56. An apparatus for performing a function, comprising one or more means for performing operations according to any of Aspects 11 to 20.

Aspect 57. A non-transitory computer-readable medium having stored thereon instructions that, when executed by at least one processor, cause the at least one processor to perform operations according to any of Aspects 31 to 40.

Aspect 58. An apparatus for performing a function, comprising one or more means for performing operations according to any of Aspects 31 to 40.

Aspect 59. A non-transitory computer-readable medium having stored thereon instructions that, when executed by at least one processor, cause the at least one processor to perform operations according to any of Aspects 48 to 54.

Aspect 60. An apparatus for performing a function, comprising one or more means for performing operations according to any of Aspects 48 to 54.

What is claimed is:

1. A method of processing images on a device, comprising:
obtaining an inpainted image based on providing a first image to an ML model;
combining the first image and a first auxiliary image of the first image into an intermediate image;
obtaining an inpainted intermediate image based on the intermediate image; and
generating a second auxiliary image from the inpainted image and the inpainted intermediate image.

2. The method of claim 1, wherein inpainted content in the inpainted image and the inpainted intermediate image are correlated based on training associated with a machine learning (ML) model.

3. The method of claim 2, wherein the ML model is configured to receive identification of content in the first image to inpaint into the inpainted image and the inpainted intermediate image.

4. The method of claim 2, wherein the ML model is trained based on a blended image dataset having a portion images that are blended with corresponding auxiliary image data.

5. The method of claim 2, wherein the ML model is configured to remove a portion of content in the first image and insert pixels generated during inference.

6. The method of claim 1, wherein the first auxiliary image and the second auxiliary image includes gain data of corresponding pixels.

7. The method of claim 1, wherein generating the second auxiliary image comprises subtracting the inpainted image from the inpainted intermediate image.

8. The method of claim 1, wherein the second auxiliary image is generated based on subtracting the first image from the inpainted image.

9. The method of claim 1, wherein, when the inpainted image is displayed by a display panel of the device, the device or the display panel is configured to apply gain of pixels in the second auxiliary image to corresponding pixels in the inpainted image.

10. The method of claim 1, wherein the first auxiliary image and the second auxiliary image includes depth data identifying a distance of pixels from an image capture device.

11. A method of processing images on a device, comprising:
determining a first transformation associated with a first image and a second image;
obtaining a first inpainted image based on providing the first image to an ML model; and
applying a second transformation to the first inpainted image to generate a second inpainted image.

12. The method of claim 11, wherein the second transformation is an inverse of the first transformation.

13. The method of claim 11, wherein learning the first transformation comprises:
dividing the first image and the second image into corresponding portions; and
determining a local transformation for each corresponding portion to cause the portion of the first image to be substantially equal to the portion of the second image.

14. A method of processing images on a device, comprising:
inpainting a first portion of a first image to generate a first inpainted image;
combining the first image with an auxiliary image to generate a first intermediate image;
learning a transformation from the first image to the first intermediate image to generate transform data;
applying the transform data to the first inpainted image to generate a second intermediate image; and
combining the second intermediate image and the first inpainted image to generate an inpainted auxiliary image.

15. The method of claim 14, further comprising:
receiving an identification of the first region to inpaint over undesirable content based on user input.

16. The method of claim 14, wherein a machine learning (ML) model is configured to learn the transformation and generate the transform data.

17. The method of claim 16, wherein an ML model is configured to apply the transform data in the first portion based to modify inpainted pixels in the first portion based on similar pixels in the first image.

18. The method of claim 14, wherein combining the second intermediate image and the first inpainted image comprises scaling pixels in the second intermediate image based on pixels from the first inpainted image.

19. The method of claim 14, wherein combining the first image with an auxiliary image comprises scaling pixels in the first image based on pixels from the auxiliary image.

20. The method of claim 14, wherein the first portion of the inpainted auxiliary image is substantially correlated to the first portion of the inpainted image.
